(19) United States
(12) Patent Application Publication
(10) Pub. No.: US 2026/0302684 A1
(43) Pub. Date: Oct. 1, 2026

(54) CONNECTOR

(71) Applicant: SUMITOMO WIRING SYSTEMS, LTD., Mie (JP)

(72) Inventor: Yuya SHINKAWA, Mie (JP)

(21) Appl. No.: 19/629,352

(22) Filed: Mar. 26, 2026

(30) Foreign Application Priority Data
Mar. 28, 2025 (JP) 2025-056465

(51) Int. Cl. H01R 13/52; H01R 13/512; H01R 24/76

(52) U.S. Cl. CPC H01R 13/5202; H01R 13/512; H01R 24/76

(57) ABSTRACT

A connector is attached to a casing by being inserted into a casing through-hole of the casing in a first direction. The connector includes: a housing; and a seal member configured to liquid-tightly seal between an outer peripheral surface of the housing and an inner peripheral surface of the casing through-hole. The housing includes: a fitting portion located on a proximal end side of the housing in the first direction and to which a mating connector is to be fitted; an insertion portion located on a distal end side of the housing in the first direction, to be inserted into the casing through-hole, and having an outer peripheral surface to which the seal member is to be attached; and a flange portion protruding from an outer peripheral surface of the fitting portion. The flange portion includes a through-hole located to overlap part of the seal member in the first direction.

### CROSS-REFERENCE TO RELATED APPLICATIONS

This application is based on and claims priority from Japanese Patent Application No. 2025-056465, filed on March 28, 2025, with the Japan Patent Office, the disclosure of which is incorporated herein in its entirety by reference.

### TECHNICAL FIELD

The present disclosure relates to a connector.

### BACKGROUND

JP 2021-140917 A discloses a device connector to be fastened to a device casing having a hole portion. The device connector according to JP 2021-140917 A includes a tubular housing, a flange portion continuous with an edge of the housing and facing the device casing, and a seal member attached to the housing and interposed between the flange portion and a peripheral edge of the hole portion.

### SUMMARY

The device connector according to JP 2021-140917 A further includes an insertion portion to be inserted into the hole portion of the device casing. In this case, in a state where the device connector is attached to the device casing, there is a risk that water accumulates in a gap surrounded by an inner peripheral surface of the hole portion of the device casing, the outer peripheral surface of the insertion portion of the device connector, and the seal member.

A connector according to the present disclosure is a connector to be attached to a casing by being inserted into a casing through-hole of the casing in a first direction, including: a housing; and a seal member configured to liquid-tightly seal between an outer peripheral surface of the housing and an inner peripheral surface of the casing through-hole, wherein the housing includes: a fitting portion located on a proximal end side of the housing in the first direction and to which a mating connector is to be fitted; an insertion portion located on a distal end side of the housing in the first direction, to be inserted into the casing through-hole, and having an outer peripheral surface to which the seal member is to be attached; and a flange portion protruding from an outer peripheral surface of the fitting portion, and the flange portion is provided with a through-hole located so as to overlap a portion of the seal member when viewed in the first direction.

With the connector according to the present disclosure, it is possible to suppress excessive accumulation of water in a gap formed between the casing through-hole of the casing and the connector.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exploded perspective view of a connector according to an embodiment.

FIG. 2 is a perspective view of a housing according to an embodiment.

FIG. 3 is a perspective view of the housing according to an embodiment viewed from another angle.

FIG. 4 is a plan view of the housing according to an embodiment.

FIG. 5 is a cross-sectional view taken along a line 5-5 in FIG. 4.

FIG. 6 is a cross-sectional view of the housing according to an embodiment attached to a casing.

FIG. 7 is a perspective view of a housing according to a modification.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, aspects of the present disclosure will be listed and described.

[1] A connector according to the present disclosure is a connector to be attached to a casing by being inserted into a casing through-hole of the casing in a first direction, including: a housing; and a seal member configured to liquid-tightly seal between an outer peripheral surface of the housing and an inner peripheral surface of the casing through-hole, wherein the housing includes: a fitting portion located on a proximal end side of the housing in the first direction and to which a mating connector is to be fitted; an insertion portion located on a distal end side of the housing in the first direction, to be inserted into the casing through-hole, and having an outer peripheral surface to which the seal member is to be attached; and a flange portion protruding from an outer peripheral surface of the fitting portion, and the flange portion is provided with a through-hole located so as to overlap a portion of the seal member when viewed in the first direction.

When the connector of the same configuration is attached to the casing, a gap surrounded by the inner peripheral surface of the casing through-hole, the outer peripheral surface of the insertion portion of the connector, the seal member, and the flange portion is formed between the connector and the casing. When water accumulates in this gap, the water accumulated in the gap can be discharged through the through-hole provided in the flange portion.

For example, by providing the through-hole in the flange portion, air easily circulates between the gap and the external space on the outer surface side of the flange portion through the through-hole. Such a structure promotes the natural evaporation of the water accumulated in the gap and the discharge of vapor generated by the natural evaporation to the external space. Further, when the attachment direction of the connector with respect to the casing is such that the first direction is oriented in a direction other than the vertical direction, for example, a horizontal direction or an upward direction, the water accumulated in the gap is discharged to the external space through the through-hole by its own weight. Therefore, it is possible to suppress excessive accumulation of water in the gap.

[2] In the above [1], the flange portion may be provided on the entire circumference of the outer peripheral surface of the fitting portion. With this configuration, since the gap is a closed space, water more easily accumulates in the gap. Therefore, the effect of discharging water from the gap by providing the through-hole becomes more pronounced. Further, with this configuration, the orientation of the connector with respect to the casing is stabilized. For example, when any portion of the outer peripheral surface of the fitting portion in the circumferential direction is not provided with the flange portion, it is possible to prevent the connector from tilting due to that portion falling into the casing through-hole.

[3] In the above [1] or [2], the fitting portion may be provided with a first protruding portion protruding from the outer peripheral surface thereof, the through-hole may be located so as to overlap the first protruding portion when viewed in the first direction, and the through-hole is shaped such that the first protruding portion fits within the through-hole when viewed in the first direction.

With this configuration, when molding the housing using a mold in which the first direction is the opening/closing direction thereof, it is possible to avoid the formation of an undercut caused by the first protruding portion being aligned with the flange portion in the first direction. Therefore, the housing having the flange portion and the first protruding portion can be molded using a mold with a simple structure in which the first direction is the opening/closing direction thereof.

[4] In the above [3], the first protruding portion may be a connector locking portion configured to lock the mating connector. With this configuration, the housing having the connector locking portion for locking the mating connector and the flange portion can be molded.

[5] In any one of the above [1] to [4], the insertion portion may be provided with a second protruding portion protruding from the outer peripheral surface thereof, the through-hole is located so as to overlap the second protruding portion when viewed in the first direction, and the through-hole may be shaped such that the second protruding portion fits within the through-hole when viewed in the first direction.

With this configuration, when molding the housing using a mold in which the first direction is the opening/closing direction thereof, it is possible to avoid the formation of an undercut caused by the second protruding portion being aligned with the flange portion in the first direction. Therefore, the housing having the flange portion and the second protruding portion can be molded using a mold having a simple structure in which the first direction is the opening/closing direction thereof.

[6] In the above [5], the second protruding portion may be a seal locking portion configured to lock the seal member. With this configuration, the housing having the seal locking portion for locking the seal member and the flange portion can be molded.

### Details of Embodiments of the Present Disclosure

Specific examples of the connector according to the present disclosure will be described below based on the drawings. In each drawing, a part of the configuration may be exaggerated or simplified for convenience of description. Further, dimensional ratios of respective parts may differ in each drawing. The terms "orthogonal" and "parallel" in the present specification include not only cases of strictly orthogonal and parallel but also cases of substantially orthogonal and parallel within a range where the action and effects of the present embodiment are exhibited. Further, terms such as "first", "second", and "third" in the present specification are used merely to distinguish objects, and do not rank the objects.

Each drawing illustrates an X-axis, a Y-axis, and a Z-axis orthogonal to each other. Hereinafter, as an example, a case where a connector 10 is disposed in an orientation where the Z-axis direction is an upward direction will be described. The connector 10 is not limited to use in this orientation, and may be used in an orientation where the Z-axis direction is a direction other than the upward direction, for example, a downward direction or a horizontal direction. Each axial direction such as the Z-axis direction means a direction in which a tip of an arrow of the corresponding axis points. In the case of the connector 10 of an example described below, a first direction D1 is a direction opposite to the Z-axis direction.

### Schematic Configuration of Connector 10

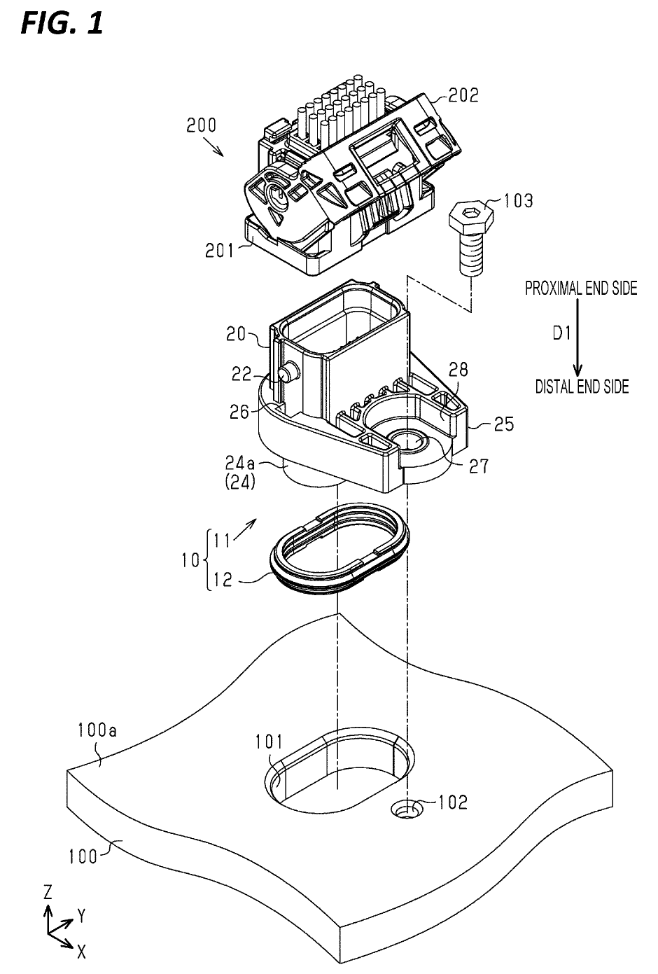

As shown in FIG. 1, the connector 10 is attached to a casing 100 by being inserted into a casing through-hole 101 of the casing 100 in the first direction D1.

The casing 100 has an attachment surface 100a, which is a surface to which the connector 10 is attached. The casing through-hole 101 is a through-hole opening in the attachment surface 100a of the casing 100. Further, a bolt hole 102 for fixing the connector 10 with a screw is provided in the attachment surface 100a of the casing 100.

A lever-equipped connector 200 is the mating connector of the connector 10. The lever-equipped connector 200 has a mating housing 201 and a lever 202 rotatably supported by the mating housing 201. The lever-equipped connector 200 is fitted to the connector 10 by rotating the lever 202 while engaging the lever 202 with a connector locking portion 22, which will be described later, of the connector 10. Note that the configuration of the lever-equipped connector 200 is not limited to the structure shown in FIG. 1, and other known configurations of the lever-equipped connector can also be applied.

### Detailed Configuration of Connector 10

As shown in FIG. 1, the connector 10 includes a housing 11 in which terminals (not shown) are accommodated. Electric wires (not shown) are connected to the terminals. The electric wires are drawn out in the first direction D1 from an end portion, on the distal end side in the first direction D1, of the housing 11.

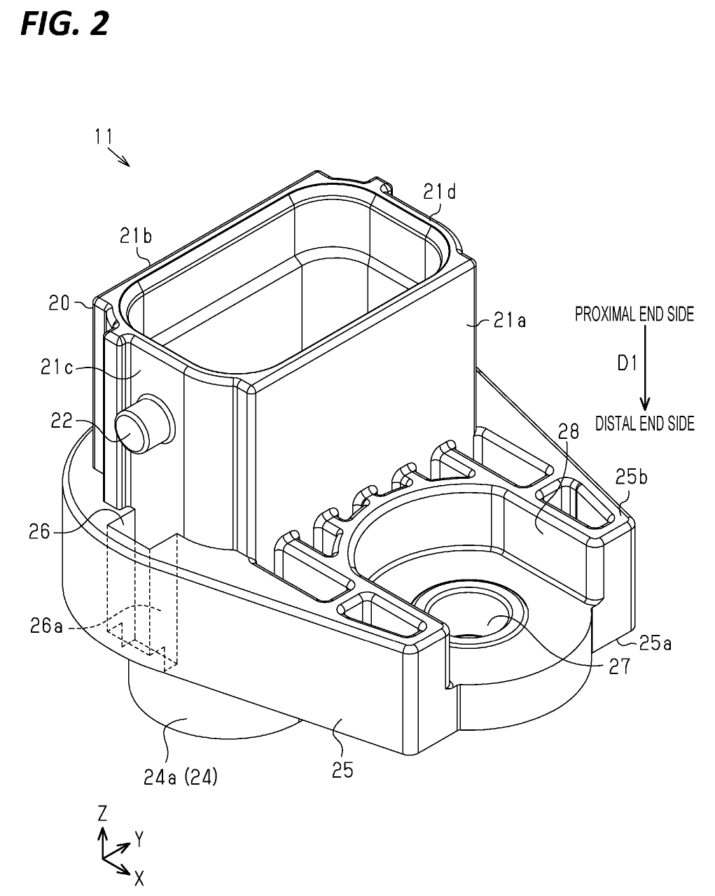

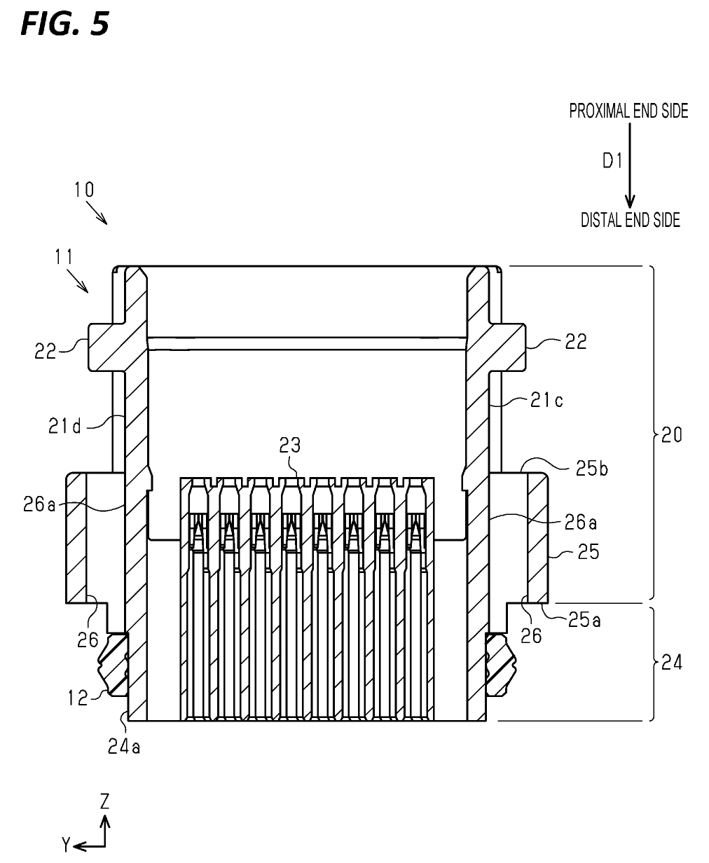

As shown in FIGS. 2 and 5, the housing 11 includes a fitting portion 20, which is located on the proximal end side in the first direction D1 and to which the lever-equipped connector 200 (the mating connector) is fitted. The fitting portion 20 has a tubular shape extending in the first direction D1. The outer shape of the fitting portion 20 is not particularly limited, and is appropriately set according to the shape of the mating connector. An example of the fitting portion 20 has a rectangular tubular shape having a first side wall 21a and a second side wall 21b disposed at an interval in the X-axis direction, and a third side wall 21c and a fourth side wall 21d disposed at an interval in the Y-axis direction.

The outer surface of the third side wall 21c is provided with a connector locking portion 22 protruding in a direction opposite to the Y-axis direction. The outer surface of the fourth side wall 21d is provided with a connector locking portion 22 protruding in the Y-axis direction. The connector locking portions 22 are portions for locking the mating connector. In the present embodiment, when fitting the lever-equipped connector 200 to the connector 10, fitting between the connector 10 and the lever-equipped connector 200 is assisted by the lever 202 of the lever-equipped connector 200 engaging with the connector locking portions 22. Each connector locking portion 22 has, for example, a columnar shape.

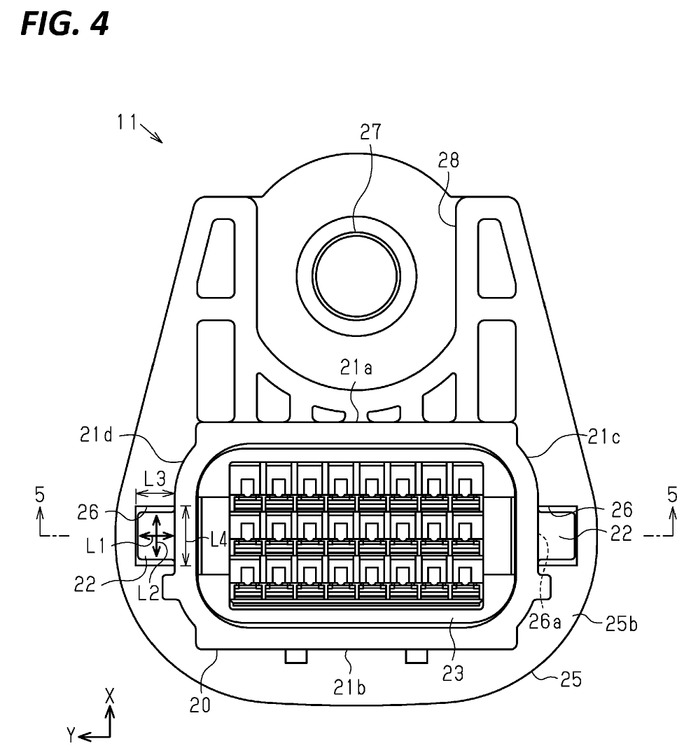

As shown in FIGS. 2 and 5, the housing 11 includes a flange portion 25 protruding from the outer peripheral surface of the fitting portion 20. As shown in FIG. 4, the flange portion 25 is formed on the entire circumference of the outer peripheral surface of the fitting portion 20. The outer peripheral surface of the fitting portion 20 means the outer surfaces of the first side wall 21a, the second side wall 21b, the third side wall 21c, and the fourth side wall 21d. The flange portion 25 is provided on the distal end side in the first direction D1 relative to the connector locking portions 22.

The flange portion 25 has a first surface 25a located on the distal end side in the first direction D1, and a second surface 25b located on the opposite side of the first surface 25a. The second surface 25b of the flange portion 25 is provided with a bolt accommodating recess 28 for accommodating the bolt 103 for fixing the connector 10 to the casing 100. The bolt accommodating recess 28 is recessed from the second surface 25b side toward the first surface 25a side. The bolt accommodating recess 28 is provided with an insertion hole 27 extending through the flange portion 25 in the first direction D1.

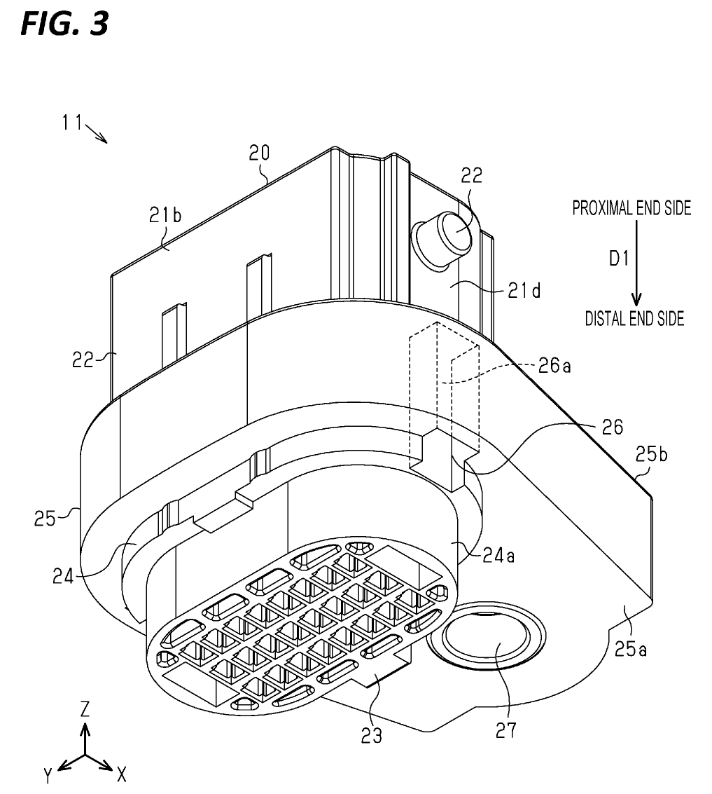

As shown in FIGS. 3 and 5, the housing 11 is provided with an insertion portion 24 located on the distal end side in the first direction D1 and inserted into the casing through-hole 101. The insertion portion 24 has a columnar shape extending in the first direction D1. The insertion portion 24 is formed integrally with the fitting portion 20 continuously from the fitting portion 20 in the first direction D1. Note that the fitting portion 20 is a portion located on the proximal end side in the first direction D1 relative to the first surface 25a of the flange portion 25 in the housing 11. The insertion portion 24 is a portion located on the distal end side in the first direction D1 relative to the first surface 25a of the flange portion 25 in the housing 11. The outer shape of the insertion portion 24 is not particularly limited, and may be the same shape as the outer shape of the fitting portion 20, or may be a shape different from that of the fitting portion 20. An example of the insertion portion 24 has an oval outer shape extending in the Y-axis direction.

A seal attachment portion 24a is provided on the outer peripheral surface of an end portion, on the distal end side in the first direction D1, of the insertion portion 24. The seal attachment portion 24a is a reduced diameter portion formed by reducing the diameter of an outer surface of the insertion portion 24 within a certain range from the edge thereof on the distal end side in the first direction D1.

As shown in FIGS. 1 and 5, a seal member 12 formed of an elastic material such as rubber is attached to the seal attachment portion 24a. The seal member 12 has an annular shape. The seal member 12 liquid-tightly seals between the housing 11 and the casing 100 in a state where the connector 10 is attached to the casing 100.

As shown in FIG. 5, a terminal accommodating portion 23 in which terminals are accommodated is provided inside the fitting portion 20 and the insertion portion 24. The terminal accommodating portion 23 is formed integrally with the inner peripheral surfaces of the fitting portion 20 and the insertion portion 24. A plurality of terminal accommodating chambers for individually accommodating terminals are defined in the terminal accommodating portion 23.

### Configuration of Through-Holes 26

As shown in FIGS. 2 to 5, the flange portion 25 is provided with through-holes 26 extending through the flange portion 25 in the first direction D1 from the second surface 25b to the first surface 25a. As shown in FIG. 5, the through-holes 26 are each located so as to overlap at least a portion of the seal member 12 in the first direction D1.

In the present embodiment, one through-hole 26 is provided in each of a portion of the flange portion 25 protruding from the third side wall 21c of the fitting portion 20 and a portion of the flange portion 25 protruding from the fourth side wall 21d of the fitting portion 20. As shown in FIG. 5, each through-hole 26 has an inner side surface 26a located on the side closer to the center of the tubular fitting portion 20. Each inner side surface 26a is flush with the outer peripheral surface of the fitting portion 20. One of the two through-holes 26 has an inner side surface 26a flush with the outer surface of the third side wall 21c of the fitting portion 20. The other of the two through-holes 26 has an inner side surface 26a flush with the outer surface of the fourth side wall 21d of the fitting portion 20.

Further, the through-holes 26 are configured to have a specific positional relationship and size with respect to the connector locking portions 22 protruding from the third side wall 21c and the fourth side wall 21d of the fitting portion 20.

The through-holes 26 are located so as to overlap the connector locking portions 22 in the flange portion 25 when viewed in the first direction D1. In other words, the through-holes 26 are arranged so as to be aligned with the connector locking portions 22 in the first direction D1.

The through-holes 26 are configured such that the connector locking portions 22 fit within the through-holes 26 when viewed in the first direction D1. For example, as shown in FIG. 4, the length in the Y-axis direction of the connector locking portions 22 in a plan view viewed in the first direction D1 is defined as a first length L1, and the length in the X-axis direction of the same is defined as a second length L2. The first length L1 is the protrusion length of the connector locking portions 22 from the outer surface of the fitting portion 20, that is, the outer surface of the third side wall 21c or the outer surface of the fourth side wall 21d. The second length L2 is a dimension of the connector locking portions 22 in a direction orthogonal to a protruding direction of the connector locking portions 22 in the above-described plan view.

Further, the length in the Y-axis direction of the through-holes 26 in the above-described plan view is defined as a third length L3, and the length in the X-axis direction of the same is defined as a fourth length L4. The third length L3 is a distance from the outer surface of the third side wall 21c or the outer surface of the fourth side wall 21d to the inner side surface of the through-hole 26 located on the distal end side of the connector locking portion 22. The fourth length L4 is the dimension of the through-hole 26 in a direction orthogonal to the protruding direction of the connector locking portion 22 in the above-described plan view. The third length L3 of the through-holes 26 is longer than the first length L1 of the connector locking portions 22. The fourth length L4 of the through-holes 26 is longer than the second length L2 of the connector locking portions 22.

### Action of the Present Embodiment

Hereinafter, the action of the present embodiment will be described.

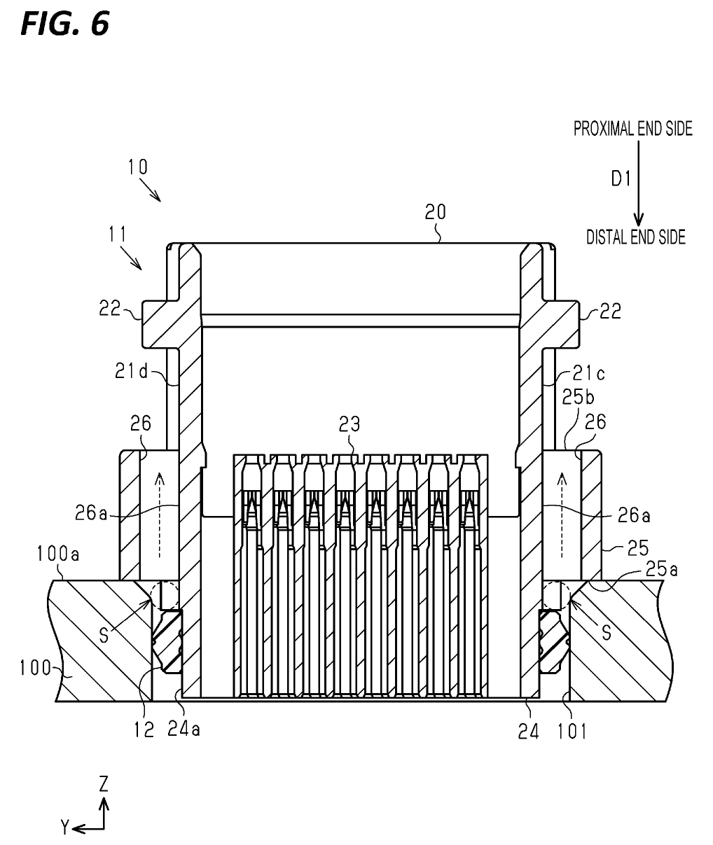

As shown in FIGS. 1 and 6, when attaching the connector 10 to the casing 100, the insertion portion 24 of the connector 10 is inserted into the casing through-hole 101 of the casing 100 in the first direction D1. Then, the connector 10 is placed on the attachment surface 100a such that the first surface 25a of the flange portion 25 is in contact with the attachment surface 100a of the casing 100 (see FIG. 6). Next, the bolt 103 is inserted into the insertion hole 27 provided in the flange portion 25 of the connector 10, and the bolt 103 is fastened to the bolt hole 102 of the casing 100 (see FIG. 1). By the above operation, the connector 10 is fixed to the casing 100.

As shown in FIG. 6, in a state where the connector 10 is attached to the casing 100, the outer peripheral surface of the seal member 12 attached to the seal attachment portion 24a of the housing 11 of the connector 10 is in close contact with the inner peripheral surface of the casing through-hole 101. Thereby, the space between the outer peripheral surface of the housing 11 and the inner peripheral surface of the casing through-hole 101 is liquid-tightly sealed.

Here, a gap S where water can accumulate is formed between the connector 10 and the casing 100. The gap S is a space surrounded by the inner peripheral surface of the casing through-hole 101 of the casing 100, the outer peripheral surface of the insertion portion 24 of the connector 10, the seal member 12, and the first surface 25a of the flange portion 25. Water or the like adhering to the surfaces of the connector 10 and the casing 100 may enter the gap S and accumulate therein.

The flange portion 25 of the connector 10 according to the present embodiment is provided with the through-holes 26. The through-holes 26 are each located so as to overlap a portion of the seal member 12 in the first direction D1. Therefore, the through-holes 26 communicate with the gap S. Therefore, as indicated by broken line arrows in FIG. 6, the connector 10 can discharge the water accumulated in the gap S through the through-holes 26.

For example, due to the through-holes 26 provided in the flange portion 25, air easily circulates between the gap S and the external space on the outer surface side of the flange portion 25 through the through-holes 26. Such a structure promotes the natural evaporation of the water accumulated in the gap S and the discharge of vapor generated by the natural evaporation to the external space. Further, when the attachment direction of the connector 10 with respect to the casing 100 is such that the first direction D1 is oriented in a direction other than the vertical direction, for example, a horizontal direction or an upward direction, the water accumulated in the gap S is discharged to the external space through the through-holes 26 by its own weight.

### Effects of the Present Embodiment

Hereinafter, effects of the present embodiment will be described.

(1) The connector 10 is attached to the casing 100 by being inserted into the casing through-hole 101 of the casing 100 in the first direction D1. The connector 10 includes a housing 11 and a seal member 12 for liquid-tightly sealing between the outer peripheral surface of the housing 11 and the inner peripheral surface of the casing through-hole 101. The housing 11 includes a fitting portion 20, which is located on the proximal end side in the first direction D1 and to which a mating connector is to be fitted, an insertion portion 24, which is located on the distal end side in the first direction D1, is to be inserted into the casing through-hole 101, and has an outer peripheral surface to which the seal member 12 is to be attached, and a flange portion 25 protruding from the outer peripheral surface of the fitting portion 20. The flange portion 25 is provided with through-holes 26 each located so as to overlap a portion of the seal member 12 in the first direction D1.

With this configuration, the through-holes 26 provided in the flange portion 25 function as passages for discharging water accumulated in the gap S formed between the casing through-hole 101 and the connector 10. Therefore, it is possible to suppress excessive accumulation of water in the gap S.

(2) The flange portion 25 is provided on the entire circumference of the outer peripheral surface of the fitting portion 20. With this configuration, the gap S is a closed space, and water more easily accumulates in the gap S. Therefore, the effect of discharging water from the gap S by providing the through-holes 26 becomes more pronounced. Further, with this configuration, the orientation of the connector 10 with respect to the casing 100 is stabilized. For example, when any portion of the outer peripheral surface of the fitting portion 20 in the circumferential direction is not provided with the flange portion 25, it is possible to prevent the connector 10 from tilting due to that portion falling into the casing through-hole 101.

(3) The through-holes 26 each have an inner side surface 26a flush with the outer peripheral surface of the fitting portion 20. With this configuration, when water is discharged from the gap S to the external space through the through-holes 26, the movement of water from the through-holes 26 to the external space is smooth compared to a case where the outer peripheral surface of the fitting portion 20 and the inner side surface 26a are connected via a step. Therefore, the water accumulated in the gap S can be discharged more efficiently.

(4) The fitting portion 20 is provided with connector locking portions 22 protruding from the outer peripheral surface thereof. The through-holes 26 are located so as to overlap the connector locking portions 22 in the first direction D1. The through-holes 26 are shaped such that the connector locking portions 22 fit within the through-holes 26 when viewed in the first direction D1. Note that the connector locking portions 22 are equivalent to a first protruding portion.

With this configuration, when molding the housing 11 using a mold in which the first direction D1 is the opening/closing direction thereof, it is possible to avoid the formation of an undercut caused by the connector locking portions 22 being aligned with the flange portion 25 in the first direction D1. Therefore, the housing 11 having the flange portion 25 and the connector locking portions 22 can be molded using a mold with a simple structure in which the first direction D1 is the opening/closing direction thereof.

### Other Embodiments

The above embodiment can be modified and implemented as follows. The above embodiment and the following modifications can be implemented in combination with each other within a range not technically contradictory.

The range in which the flange portion 25 is formed is not limited to the entire circumference of the outer peripheral surface of the fitting portion 20, and may be a portion of the outer peripheral surface of the fitting portion 20 in the circumferential direction. Further, the shape of the flange portion 25 is not limited to that in the above embodiment.

The inner side surfaces 26a of the through-holes 26 do not have to be flush with the outer peripheral surface of the fitting portion 20. For example, the inner side surfaces 26a of the through-holes 26 may protrude beyond the outer peripheral surface of the fitting portion 20, or may be recessed from the outer peripheral surface of the fitting portion 20.

In the above embodiment, the connector locking portions 22 are provided as the first protruding portion protruding from the outer peripheral surface of the fitting portion 20, but the first protruding portion is not limited to the connector locking portions 22. The first protruding portion may be a protruding portion used for a purpose other than locking the mating connector as long as the first protruding portion is a protruding portion protruding from the outer peripheral surface on the proximal end side in the first direction D1 relative to the flange portion 25 in the fitting portion 20. The connector locking portions 22 may be omitted and another first protruding portion may be provided, or another first protruding portion may be provided in addition to the connector locking portions 22. In the case where a plurality of first protruding portions are provided at a plurality of positions on the fitting portion 20, it is preferable to arrange the first protruding portions so that the first protruding portions do not overlap each other in the first direction D1, and provide the through-holes 26 configured to have the above specific positional relationship and size with respect to the first protruding portions. Thereby, the effect described in (4) above is obtained.

The positions of the through-holes 26, the number of the through-holes 26, and the shape of the through-holes 26 are not limited to the above embodiment. For example, the through-holes 26 may be provided at positions not overlapping the connector locking portions 22 in the first direction D1. Further, the number of the through-holes 26 may be larger or smaller than the number of the connector locking portions 22. Further, the shape of the through-holes 26 may be a shape in which the connector locking portions 22 do not fit within the through-holes 26 when viewed in the first direction D1. Also, when providing a plurality of through-holes 26, specific configurations such as the shape and arrangement thereof can be set independently for each through-hole 26.

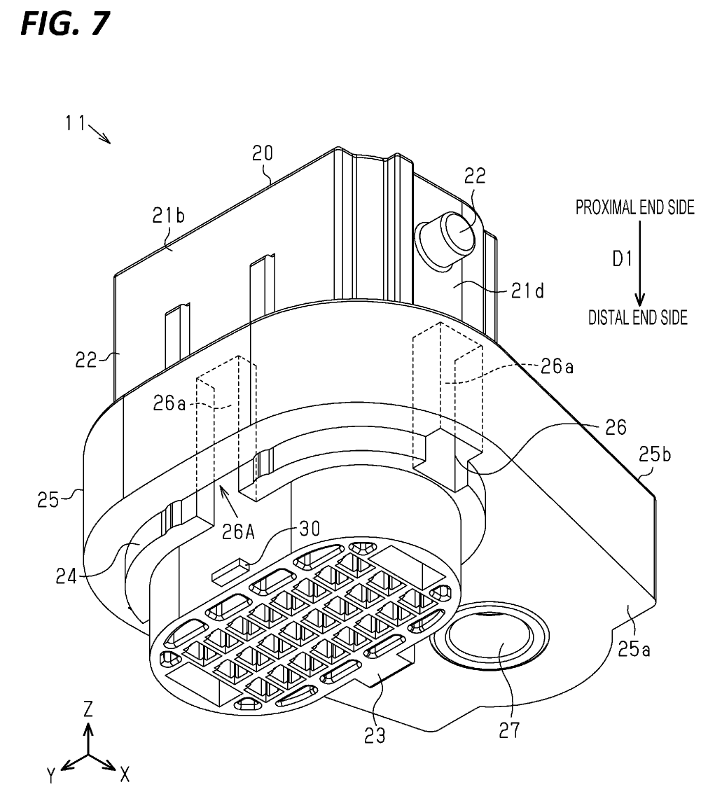

For example, as shown in FIG. 7, a through-hole 26A may be configured to have a specific positional relationship and size with respect to a second protruding portion 30 protruding from the outer peripheral surface of the insertion portion 24 of the housing 11. The second protruding portion 30 is, for example, a seal locking portion for locking the seal member 12 attached to the seal attachment portion 24a from the distal end side in the first direction D1, and protrudes from the outer peripheral surface of the seal attachment portion 24a.

The through-hole 26A is located so as to overlap the second protruding portion 30 in the flange portion 25 when viewed in the first direction D1. In other words, the through-hole 26A is arranged so as to be aligned with the second protruding portion 30 in the first direction D1. The through-hole 26A is configured such that the second protruding portion 30 fits within the through-hole 26A when viewed in the first direction D1.

In this case, when molding the housing 11 using a mold in which the first direction D1 is the opening/closing direction thereof, it is possible to avoid the formation of an undercut caused by the second protruding portion 30 being aligned with the flange portion 25 in the first direction D1. Therefore, the housing 11 having the flange portion 25 and the second protruding portion 30 can be molded using a mold having a simple structure in which the first direction D1 is the opening/closing direction thereof.

Further, the through-hole 26A may have an inner side surface 26a located on the side closer to the center of the tubular fitting portion 20. The inner side surface 26a is flush with the outer peripheral surface of the fitting portion 20. Note that the second protruding portion 30 may be a protruding portion used for a purpose other than locking the seal member 12 as long as it is a protruding portion protruding from the outer peripheral surface of the insertion portion 24.

The mating connector is not limited to the lever-equipped connector 200. The connector locking portion 22 can be omitted depending on the configuration of the mating connector.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector to be attached to a casing by being inserted into a casing through-hole of the casing in a first direction, comprising:
a housing; and
a seal member configured to liquid-tightly seal between an outer peripheral surface of the housing and an inner peripheral surface of the casing through-hole,
wherein the housing includes:
a fitting portion located on a proximal end side of the housing in the first direction and to which a mating connector is to be fitted;
an insertion portion located on a distal end side of the housing in the first direction, to be inserted into the casing through-hole, and having an outer peripheral surface to which the seal member is to be attached; and
a flange portion protruding from an outer peripheral surface of the fitting portion, and
the flange portion is provided with a through-hole located so as to overlap a portion of the seal member when viewed in the first direction.

2. The connector according to claim 1,
wherein the flange portion is provided on an entire circumference of the outer peripheral surface of the fitting portion.

3. The connector according to claim 1,
wherein the fitting portion is provided with a first protruding portion protruding from the outer peripheral surface thereof,
the through-hole is located so as to overlap the first protruding portion when viewed in the first direction, and
the through-hole is shaped such that the first protruding portion fits within the through-hole when viewed in the first direction.

4. The connector according to claim 3,
wherein the first protruding portion is a connector locking portion configured to lock the mating connector.

5. The connector according to claim 1,
wherein the insertion portion is provided with a second protruding portion protruding from the outer peripheral surface thereof,
the through-hole is located so as to overlap the second protruding portion when viewed in the first direction, and
the through-hole is shaped such that the second protruding portion fits within the through-hole when viewed in the first direction.

6. The connector according to claim 5,
wherein the second protruding portion is a seal locking portion configured to lock the seal member.
